(19) United States
(12) Patent Application Publication
(10) Pub. No.: US 2026/0339798 A1
(43) Pub. Date: Oct. 29, 2026

(54) COUPLING SYSTEM, COUPLING METHOD AND COUPLING PROGRAM

(71) Applicant: NTT, Inc., Tokyo (JP)

(72) Inventors: Tetsuya FUKUDA, Musashino-shi, Tokyo (JP); Yohei TSUKADA, Musashino-shi, Tokyo (JP); Masahiro MARUYOSHI, Musashino-shi, Tokyo (JP)

(73) Assignee: NTT, Inc., Tokyo (JP)

(21) Appl. No.: 19/110,110

(22) PCT Filed: Oct. 18, 2022
(86) PCT No.: PCT/JP2022/038772

§ 371 Date: Mar. 10, 2025

(51) Int. Cl. G06F 11/26

(52) U.S. Cl. CPC G06F 11/261

(57) ABSTRACT

A coupling system includes a master and a worker corresponding to a simulator, wherein the master includes a storage that has a region where data is stored for each division of a name space, and the worker includes a storage that stores a table in which the division of the name space is associated with information for specifying the simulator, and first processing circuitry configured to generate data to be transmitted to the master by using an acquired execution result from the simulator and the division of the name space corresponding to the simulator of a transmission destination specified with reference to the table, and transmit the generated data to the region corresponding to the division of the name space of the master.

### TECHNICAL FIELD

The present invention relates to a coupling system, a coupling method, and a coupling program.

### BACKGROUND ART

In coupling technique fields of the related art for constructing one simulation by combining a plurality of simulation tools, functional mock-up interface (FMI: see NPL 1) that is a standard formulated for handling continuous time simulation and a high level architecture (HLA: see NPL 2) that is a standard formulated for executing discrete time event-based simulation have been proposed. FMI is a standard formulated for handling a continuous time simulation. HLA is a standard formulated for executing a discrete time event-based simulation.

In coupling techniques of the related art, information is exchanged between simulators at a given timing while independently operating a plurality of simulators, and each simulator gives information received from other simulators as an input to the own simulator and performs calculation until exchanges of next information. The coupling is executed by a master-slave architecture, and data is exchanged between simulators via a master.

### CITATION LIST

### Non Patent Literature

[NPL 1] Modelica Association, “Functional Mock-up Interface for Model Exchange and Co-Simulation Document version: 2.0.2”, [online], [retrieved on Sep. 13, 2022], the Internet <URL:https://github.com/modelica/fmi-standard/releases/download/v2.0.2/FMI-Specification-2.0.2.pdf>

[NPL 2] IEEE Computer Society, “IEEE Standard for Modeling and Simulation (M&S) High Level Architecture (HLA) Federate Interface Specification”

### SUMMARY OF INVENTION

### Technical Problem

However, in the techniques of the related art, there is concern of a load of data exchange processing in a master becoming excessive and thus a bottleneck occurring. For example, when a plurality of simulators is combined, one master manages a plurality of workers. Since all data exchanges between workers are executed via a master, data exchange processing in the master becomes a bottleneck when the number of simulators of coupling targets or the size of data increases.

The present invention has been devised in view of the foregoing circumstances, and an object of the present invention is to reduce a load of data exchange processing in a master according to a coupling technique.

### Solution to Problem

In order to solve the above-described problem and achieve the object, a coupling system according to an aspect of the present invention includes a master and a worker corresponding to a simulator, wherein the master includes a storage unit that has a region where data is stored for each division of a name space, and the worker includes a storage unit that stores a table in which the division of the name space is associated with information for specifying the simulator, a generation unit that generates data to be transmitted to the master by using an acquired execution result from the simulator and the division of the name space corresponding to the simulator of a transmission destination specified with reference to the table, and a transmission unit that transmits the generated data to the region corresponding to the division of the name space of the master.

### Advantageous Effects of Invention

According to the present invention, it is possible to reduce a load of data exchange processing in a master according to a coupling technique.

### BRIEF DESCRIPTION OF DRAWINGS

FIG. 1 is a diagram illustrating an overview of a coupling system.

FIG. 2 is a diagram illustrating the overview of the coupling system.

FIG. 3 is a diagram illustrating the overview of the coupling system.

FIG. 4 is a schematic diagram illustrating an overall configuration of the coupling system.

FIG. 5 is a sequence diagram illustrating a coupling processing procedure.

FIG. 6 is a diagram illustrating a computer that executes a coupling program.

### DESCRIPTION OF EMBODIMENTS

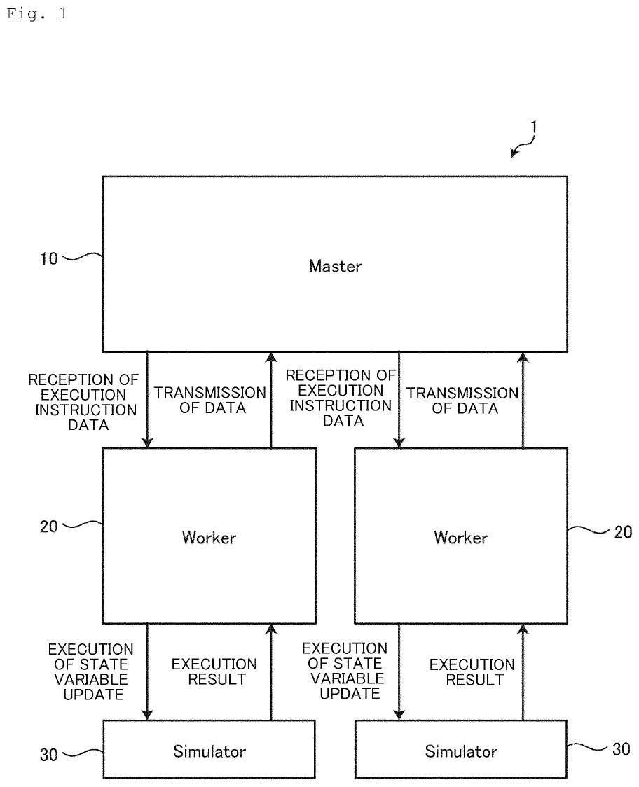

Hereinafter, an embodiment of the present invention will be described in detail with reference to the drawings. The present invention is not limited by the embodiment. In the description of the drawings, the same constituent elements are denoted by the same reference numerals.

[Overview of System] FIGS. 1 to 3 are diagrams illustrating an overview of a coupling system. The coupling system combines a plurality of simulators and executes one simulation as a whole. In the coupling system, data exchange between simulators is executed at a given timing while independently operating the simulators under the control of a master, and processing of each simulator is executed in parallel.

As illustrated in FIG. 1, the coupling system 1 according to the present embodiment has a master 10, a worker 20, and a simulator 30. Each worker 20 disposed to correspond to each simulator 30 generates transmission data from an execution result of each simulator 30 and transmits the transmission data to the master 10. The master 10 manages the received data in a message queue. Then, data is transmitted to the simulator 30 at a predetermined endpoint via the corresponding worker 20. In this way, the data exchange between the simulators 30 is executed via the message queue of the master 10.

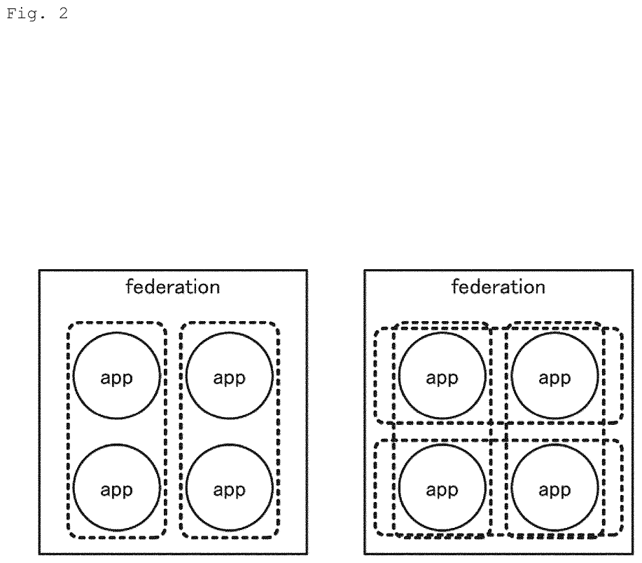

Here, in the HLA of the related art, a plurality of applications (apps) is grouped in units of federation (authentication) illustrated in FIG. 2, and data exchange is realized between applications in the group. Here, the applications mean a combination of simulator and corresponding worker (Simulator+Worker).

On the other hand, the coupling system 1 according to the present embodiment enables grouping in units finer than federation, as indicated by a broken line of a thick line in FIG. 2. According to the coupling system 1, for example, data coupling across federations will become possible, such as in reflection of land use changes in society in climate field simulators.

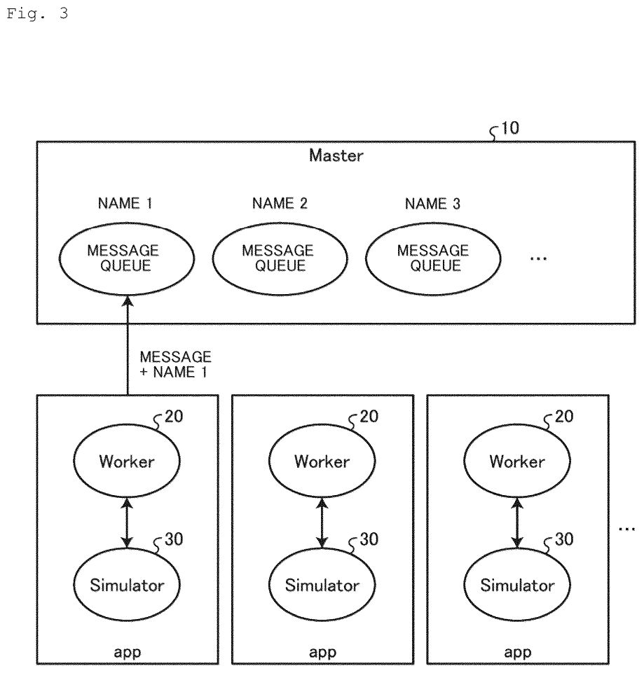

Specifically, as exemplified in FIG. 3, the worker 20 designates divisions (name 1, name 2, . . . ) of name spaces indicating endpoints of messages including exchange data. For example, a region for defining the division of the name space is provided in a message transmitted by the worker 20. In the master 10, a message queue is prepared for each division in the name space. Accordingly, the worker 20 executes data exchange via the message queue.

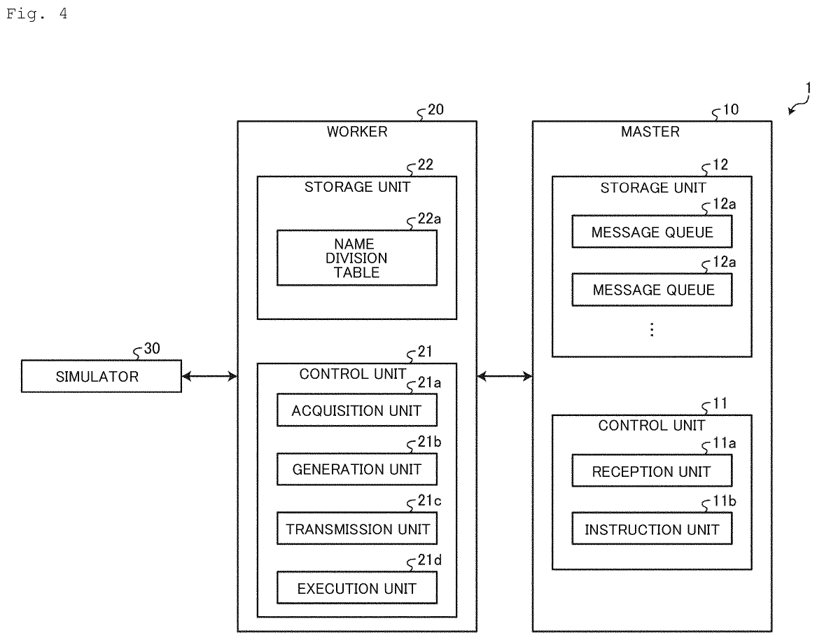

The division in the name space is determined according to a frequency of data exchange or determined so that the size of data to be exchanged is evenly distributed. Accordingly, the amount of data and the number of requests to be processed in the master 10 are distributed and equalized, and thus load distribution is possible. Thus, it is possible to prevent data exchange in the master 10 from becoming a bottleneck due to an excessive amount of data/number of requests.

[Configuration of Coupling System] FIG. 4 is a schematic diagram illustrating an exemplary overall configuration of the coupling system. As exemplified in FIG. 4, the coupling system 1 includes the master 10 and the worker 20, and controls data exchange between the simulators 30 through coupling processing to be described below.

[Configuration of Worker] The worker 20 is realized with a central processing unit (CPU), a network processor (NP), a field programmable gate array (FPGA), or the like, executes a processing program stored in a memory, and functions as a control unit 21. The worker 20 includes a storage unit 22 realized with a semiconductor memory element such as a flash memory or a RAM. In addition, the worker 20 includes a communication control unit (not illustrated) and communicates with an external device such as the master 10 or the simulator 30 via the communication control unit. The storage unit 22 may be configured to communicate with the control unit 21 via the communication control unit.

According to the present embodiment, the storage unit 22 stores a name division table 22a in which a division of a name space is associated with information for specifying the simulator. As an item of each piece of information of the name division table 22a, the division of the name space and information for specifying the endpoint of a message queue 12a of the master 10 to be described below, that is, a set of simulators 30 exchanging information are included. For example, name 1 is associated with an endpoint specified with name 1.

As described above, the division of the name space is determined in advance at a frequency of data exchange. Alternatively, a size of data to be exchanged may be determined to be evenly distributed.

The control unit 21 functions as an acquisition unit 21a, a generation unit 21b, a transmission unit 21c, and an execution unit 21d. The control unit 21 may include other functional units.

The acquisition unit 21a acquires an execution result from the simulator 30. Specifically, the execution unit 21d to be described below causes the simulator 30 subordinate to the own worker 20 to execute processing using an instruction by the master 10 as a trigger. The acquisition unit 21a acquires an execution result. The acquisition unit 21a may store the acquired execution result in the storage unit 22.

The generation unit 21b generates data to be transmitted to the master 10 by using the acquired execution result from the simulator 30 and the division of the name space corresponding to the simulator 30 of the transmission destination specified with reference to the name division table 22a.

Specifically, the generation unit 21b generates data to be transmitted to the simulator 30 of the transmission destination by using the execution result. At that time, the generation unit 21b executes data conversion for specifying the division of the name space of an endpoint corresponding to the simulator 30 of the transmission destination with reference to a name division table 22a and adds the division of the name space of the specified names 1 and 2 to the data. The generation unit 21b includes the execution result in data to be transmitted as metadata.

The generation unit 21b may generate data to be transmitted to the master 10 by using the divisions of the plurality of name spaces. That is, data can be transmitted from a single application to an endpoint of the message queue 12a corresponding to the divisions of the plurality of name spaces.

For example, the generation unit 21b generates transmission data to be multicast using the same data for the division of the name space of a plurality of endpoints. Alternatively, the generation unit 21b may generate transmission data using data different for each division. In this way, the worker 20 can distribute the transmission destination of the data to the divisions of the name space.

The transmission unit 21c transmits the generated data (hereinafter also referred to as a message) to the message queue 12a that is a region corresponding to the division of the name space of the master 10.

The execution unit 21d causes the corresponding simulator 30 to execute processing when an instruction is given by the master 10. Specifically, the execution unit 21d causes the simulator 30 under the control of the own worker 20 to execute processing for a given time step using an instruction from the master 10 as a trigger. The execution unit 21d rewrites a state variable when the data of the execution result of another simulator 30 is received.

For example, when a message including the execution result of the other simulator is received from the master 10, the execution unit 21d confirms the division of the name space added to the message, and the state variable of the simulator 30 is rewritten for the corresponding subordinate simulator 30 with reference to the name division table 22a. The execution unit 21d transmits the received execution result of the other simulator 30 to the simulator 30 to cause the simulator 30 to execute processing.

[Configuration of Master] The master 10 is realized with a CPU, an NP, an FPGA, or the like and executes a processing program stored in a memory to function as the control unit 11. The master 10 includes a storage unit 12 realized with a semiconductor memory element such as a flash memory or a RAM. The master 10 includes a communication control unit (not illustrated) and communicates with the worker 20, another network device, or the like via the communication control unit.

According to the embodiment, the storage unit 12 has a message queue 12a that is a region where data for each division of the name space is stored. That is, a plurality of message queues 12a corresponding to the divisions of the name space are set in the storage unit 12.

The control unit 11 functions as a reception unit 11a and an instruction unit 11b. The control unit 11 may include another functional unit.

The instruction unit 11b transmits the stored data to the worker 20 corresponding to the simulator 30 corresponding to the division of the name space of the message queue 12a and gives an instruction for processing in the simulator 30. For example, the instruction unit 11b transmits the stored data to the worker 20 corresponding to a preset endpoint at a prescribed timing for each message queue 12a.

In the worker 20 receiving the message, the execution unit 21d rewrites the state variable of the simulator 30 subordinate to the own worker 20 corresponding to the division of the name space added to the message, as described above. The execution unit 21d transmits the received execution result of another simulator 30 to the simulator 30 to cause the simulator 30 to execute processing.

In the master 10, the stored data may be shared between the predetermined message queues 12a. For example, the preset message queue 12a performs data exchange. Accordingly, the message queue 12a of which the divisions of the name space, that is, endpoints, are different can share data. Thus, an execution result of a certain simulator 30 can be acquired by the other simulators 30 in which the endpoints of the message queues 12a, that is, the divisions of the name space, are different.

In this way, by setting the message queue for each division of the name space, it is possible to perform data exchange similar to the distributed message queue including a plurality of endpoints. Alternatively, client processing can also be executed to synchronize data among a plurality of non-distributed message queues 12a.

The reception unit 11a may store the received data as past data. For example, the reception unit 11a may back up past exchange data or may set a retention policy of the message queue 12a to be not deleted. Accordingly, I for example, when the distributed message queue is designed to be eventually consistent, a rollback can be executed along with time management of the entire coupling system using a mechanism of a logical time.

That is, only the simulator 30 in which delay of information occurs and the simulator 30 that has a causal relationship with the simulator 30 can be rolled back. For example, when the data received by the execution unit 21d of the worker 20 includes information corresponding to the past time step, the reception unit 11a of the master 10 receives a notification and specifies the related worker 20 and simulator 30. The instruction unit 11b gives an instruction to execute the rollback using the past exchange data.

Accordingly, the rollback of only a group of the simulators 30 extending over a plurality of message queues can be executed, and the rollback of the entire coupling is not required. Therefore, the effective efficiency is improved.

For example, in coupling between geographically distributed bases or coupling of a configuration in which calculation of each simulator is heavy and a waiting time is long, when a plurality of simulator applications executes processing in parallel, each simulator application executes calculation while extrapolating data scheduled to be received.

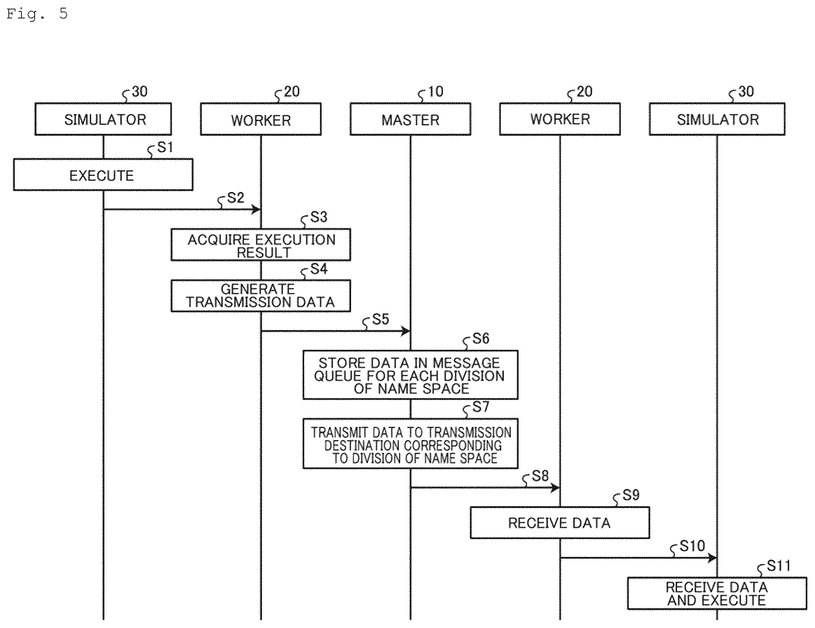

In this way, synchronization between the message queues 12a is executed at a timing asynchronous with message exchange between the simulators 30 belonging to divisions of a different name space in a steady state, and deviation in a value is confirmed with reference to a synchronization result. By executing the rollback only when there is a large deviation in the value, the number of rollbacks and a range of the rollback can be reduced to the minimum.

[Coupling Processing] Next, coupling processing by the coupling system 1 according to the embodiment will be described with reference to FIG. 5. FIG. 5 is a sequence diagram illustrating a coupling processing procedure. A sequence of FIG. 5 is, for example, started at a timing at which a user inputs an operation of giving an instruction to start the coupling processing.

First, the execution unit 21d of the worker 20 causes the simulator 30 subordinate to the own worker to execute processing using an instruction by the master 10 as a trigger (step S1). Then, the acquisition unit 21a acquires an execution result (steps S2 and S3). The generation unit 21b generates data to be transmitted to the simulator 30 of the transmission destination by using the execution result (step S4).

At that time, the generation unit 21b executes data conversion for specifying the division of the name space of the endpoint corresponding to the simulator 30 of the transmission destination with reference to the name division table 22a and adds the specified division of the name space to the data. The generation unit 21b includes the execution result in data to be transmitted as metadata. The transmission unit 21c transmits the generated data to the message queue 12a corresponding to the division of the name space of the master 10 (step S5).

In the master 10, the received data is stored in the message queue 12a provided for each of the added divisions of the name space (step S6).

The instruction unit 11b transmits the stored data to the worker 20 corresponding to the simulator 30 of the transmission destination preset to correspond to the division of the name space at a predetermined timing for each message queue 12a (steps S7 and S8).

In the worker 20 receiving the data, the execution unit 21d rewrites the state variable of the simulator 30 subordinate to the own worker 20 corresponding to the added division of the name space. The execution unit 21d transmits the received execution result of the other simulator 30 to the simulator 30 (steps S9 and S10) and executes processing (step S11). Accordingly, a series of the steps of coupling processing is completed.

[Effects] As described above, in the coupling system 1 including the master 10 and the worker 20 corresponding to the simulator 30, the storage unit 12 in the master 10 includes the message queue 12a that is a region where data is stored for each division of the name space. In the worker 20, the storage unit 22 stores the name division table 22a in which the division of the name space is associated with information for specifying the simulator. The generation unit 21b generates data to be transmitted to the master 10 by using the acquired execution result from the simulator 30 and the division of the name space corresponding to the simulator 30 of the transmission destination specified with reference to the name division table 22a. The transmission unit 21c transmits the generated data to the message queue 12a corresponding to the division of the name space of the master 10.

Further, in the master 10, the instruction unit 11b transmits the stored data to the worker 20 corresponding to the simulator 30 corresponding to the division of the name space of the message queue 12a and gives an instruction for the processing in the simulator 30. In the worker 20, when the instruction is given by the master 10, the execution unit 21d causes the corresponding simulator 30 to execute processing.

Here, in the related art, processing is distributed in units of topics defined for each use case in the message queue of the master 10. On the other hand, in this embodiment, the worker 20 selectively uses the plurality of message queues 12a in the division of the name space, and thus the user can explicitly design load sharing while using them in a plurality of use cases according to a communication pattern during the coupling. In this way, the simulator applications are grouped in units finer than federation units, and load balance can be adjusted flexibly.

Accordingly, the amount of data and the number of requests to be processed in the master 10 are distributed and equalized, and load distribution becomes possible. Therefore, it is possible to prevent data exchange in the master 10 from becoming a bottleneck due to excessive data amount/number of requests.

The generation unit 21b generates data to be transmitted to the master 10 by using the divisions of the plurality of name spaces. Accordingly, the worker 20 can distribute the transmission destination of data to the divisions of the name space.

In the master 10, the stored data is shared between predetermined message queues 12a. Accordingly, data exchange in various forms can be flexibly realized by realizing a function equivalent to that of a distributed message queue including the plurality of endpoints by using the divisions of the plurality of name spaces.

The reception unit 11a stores the transmitted data as past data. Accordingly, for example, only for the simulator 30 related to the simulator 30 in which the delay of information occurs, the rollback can be efficiently executed in a minimum number of times in the minimum range.

[Program] A program in which processing executed by the master 10 and the worker 20 according to the foregoing embodiment is described in a computer-executable language can be generated. As an embodiment, the master 10 and the worker 20 can be implemented by installing a coupling program that executes the foregoing coupling processing as package software or online software on a desired computer. For example, by causing an information processing device to execute the foregoing coupling program, it is possible to cause the information processing device to function as the master 10 and the worker 20. In addition, the information processing device also includes a mobile communication terminal such as a smartphone, a portable phone, and a personal handyphone system (PHS) and a slate terminal such as a personal digital assistant (PDA). Functions of the master 10 and the worker 20 may be implemented on a cloud server.

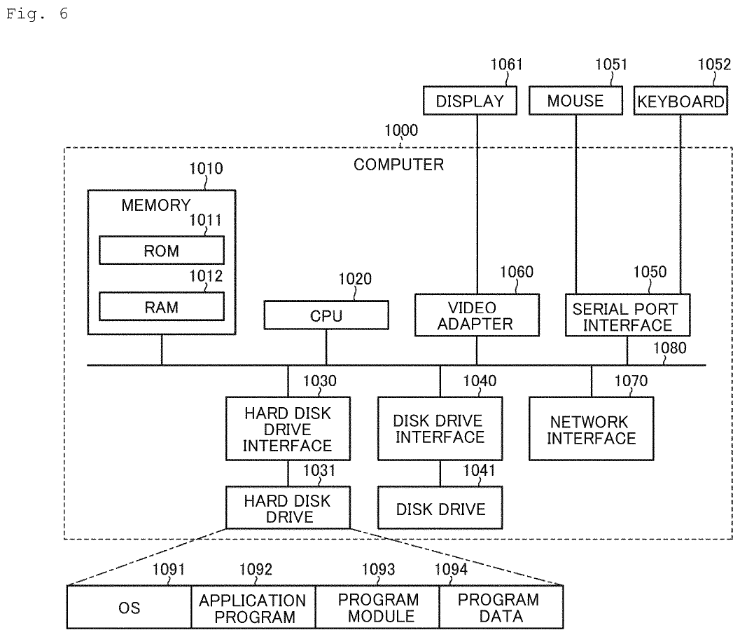

FIG. 6 is a diagram illustrating an example of a computer that executes the coupling program. A computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. A detachable storage medium such as a magnetic disk or an optical disc is inserted into the disk drive 1041. For example, a mouse 1051 and a keyboard 1052 are connected to the serial port interface 1050. For example, a display 1061 is connected to the video adapter 1060.

Here, the hard disk drive 1031 stores, for example, an OS 1091, an application program 1092, a program module 1093, and program data 1094. Each piece of information described in the foregoing embodiment is stored in, for example, the hard disk drive 1031 or the memory 1010.

The coupling program is stored in the hard disk drive 1031 as, for example, the program module 1093 in which an instruction executed by the computer 1000 is described. Specifically, the program module 1093 in which each processing executed by the master 10 and the worker 20 described in the foregoing embodiment is described is stored in the hard disk drive 1031.

Data used for information processing by the coupling program is stored in, for example, the hard disk drive 1031 as the program data 1094. The CPU 1020 reads the program module 1093 and the program data 1094 stored in the hard disk drive 1031 to the RAM 1012 and executes each of the above-described procedures, as necessary.

The program module 1093 and the program data 1094 related to the coupling program are not limited to the case where the program module 1093 and the program data 1094 are stored in the hard disk drive 1031. The program module 1093 and the program data 1094 may be stored in, for example, a detachable storage medium and may be read by the CPU 1020 via the disk drive 1041. Alternatively, the program module 1093 and the program data 1094 related to the coupling program may be stored in another computer connected via a network such as a local area network (LAN) or a wide area network (WAN) and may be read by the CPU 1020 via the network interface 1070.

Although embodiments to which the invention made by the present inventor is applied have been described above, the present invention is not limited to the description and drawings that are parts of the disclosure of the present invention according to the present embodiments. That is, all other embodiments, examples, operational techniques, and the like made by those skilled in the art based on the embodiment are included in the scope of the present invention.

### REFERENCE SIGNS LIST

1 Coupling system
10 Master
11, 21 Control unit
11a Reception unit
11b Instruction unit
12, 22 Storage unit
12a Message queue
20 Worker
21a Acquisition unit
21b Generation unit
21c Transmission unit
21d Execution unit
22a Name division table
30 Simulator

1. A coupling system comprising a master and a worker corresponding to a simulator,
wherein the master includes
a storage that has a region where data is stored for each division of a name space, and
the worker includes:
a storage that stores a table in which the division of the name space is associated with information for specifying the simulator; and
first processing circuitry configured to:
generate data to be transmitted to the master by using an acquired execution result from the simulator and the division of the name space corresponding to the simulator of a transmission destination specified with reference to the table, and
transmit the generated data to the region corresponding to the division of the name space of the master.

2. The coupling system according to claim 1, wherein the master further includes second processing circuitry configured to transmit the stored data to a worker corresponding to the simulator corresponding to the division of the name space of the region, and give an instruction for processing in the simulator.

3. The coupling system according to claim 2, wherein the first processing circuitry is further configured to cause a corresponding simulator to execute processing when the instruction is given by the master.

4. The coupling system according to claim 1, wherein the first processing circuitry is further configured to generate data to be transmitted to the master by using a plurality of divisions of the name space.

5. The coupling system according to claim 4, wherein the master shares the stored data between predetermined regions.

6. The coupling system according to claim 1, wherein the second processing circuitry is further configured to store the transmitted data as past data.

7. A coupling method executed by a coupling system including a master and a worker corresponding to a simulator,
wherein the master includes a storage that has a region where data is stored for each division of a name space,
the worker includes a storage that stores a table in which the division of the name space is associated with information for specifying the simulator, and
the coupling method includes
generating data to be transmitted to the master by using an acquired execution result from the simulator and the division of the name space corresponding to the simulator of a transmission destination specified with reference to the table, and
transmitting the generated data to the region corresponding to the division of the name space of the master.

8. A non-transitory computer-readable recording medium storing therein a coupling program that causes a computer to execute a process comprising:
wherein the master includes a storage that has a region where data is stored for each division of a name space,
the worker includes a storage that stores a table in which the division of the name space is associated with information for specifying the simulator, and
the process includes
generating data to be transmitted to the master by using an acquired execution result from the simulator and the division of the name space corresponding to the simulator of a transmission destination specified with reference to the table, and
transmitting the generated data to the region corresponding to the division of the name space of the master.
